(19) United States
(12) Patent Application Publication
(10) Pub. No.: US 2013/0215111 A1
(43) Pub. Date: Aug. 22, 2013

(54) DISPLAY DEVICE, METHOD FOR CONTROLLING DISPLAY DEVICE, PROGRAM AND RECORDING MEDIUM

(71) Applicant: Yohsuke Yokoyama, Osaka (JP)

(72) Inventor: Yohsuke Yokoyama, Osaka (JP)

(73) Assignee: SHARP KABUSHIKI KAISHA, Osaka (JP)

(21) Appl. No.: 13/882,704

(22) PCT Filed: Nov. 7, 2011
(86) PCT No.: PCT/JP2011/075633

§ 371 Date: Apr. 30, 2013

(30) Foreign Application Priority Data
Nov. 12, 2010 (JP) 2010-253876

(51) Int. Cl. H04N 13/02

(52) U.S. Cl. CPC H04N 13/0289
USPC 345/419

(57) ABSTRACT

Provided is a display device 1 for performing two-dimensional display and three-dimensional display of an image, the display device 1 being provided with: a display unit 10 for displaying the image; a plurality of cylindrical convex lenses 2 that are arranged in parallel on the screen of the display unit 10 so that the longitudinal direction thereof is positioned along a straight line that links one end of the screen with the other end; and a display control unit 4 for determining whether the image is to be displayed two-dimensionally or three-dimensionally, depending on the proximity of the longitudinal direction of the lenses 2 to one of the vertical direction and horizontal direction. If the longitudinal direction of the lenses 2 is closer to the vertical direction, the display control unit 4 causes the image to be displayed three-dimensionally. If the longitudinal direction of the lenses 2 is closer to the horizontal direction, the display control unit 4 causes the image to be displayed two-dimensionally.

### TECHNICAL FIELD

The present invention relates to a display device provided with two-dimensional and three-dimensional display functions, a method for controlling the display device, a program, and a recording medium.

### BACKGROUND ART

Various types of portable devices such as personal digital assistants, portable computers, and mobile phones have recently been becoming smaller and gaining more functions. In particular, display devices provided with three-dimensional (3D) display functions that display stereoscopic images on a screen are gaining attention.

The parallax barrier method and the lenticular method are known as methods to realize 3D display. In the parallax barrier method, a plate (such as a retardation plate, for example) with slits is arranged on the front of a display panel, and an image for the left eye is displayed to one of two adjacent pixels, and an image for the right eye is displayed to the other pixel, thereby letting the viewer view a 3D image. In the lenticular method, a lenticular lens with a plurality of elongated lenses with a cylindrical convex shape is arranged on the front of a display panel, and an image for the left eye is displayed in one of two adjacent pixels, and an image for the right eye is displayed in the other pixel, thereby letting the viewer view a 3D image. Described in Patent Document 1 is 3D display technology that uses the parallax barrier method.

### RELATED ART DOCUMENTS

### Patent Documents

Patent Document 1: Japanese Patent Application Laid-Open Publication, “Japanese Patent Application Laid-Open Publication No. 2004-129029 (Published on Apr. 22, 2004)”

### SUMMARY OF THE INVENTION

### Problems to be Solved by the Invention

The image to be displayed sometimes includes text data such as e-mail text, for example, but the text data becomes hard to see when displayed in 3D. There is also the possibility that the user wishes to have 2D display in some cases.

However, in the conventional lenticular method, it is difficult to switch from 3D display to 2D display on one screen. If the whole screen is used for 3D display, the lenticular lens will cover the entire screen, thus it is not possible to shift the lenticular lens, and to realize 2D display, the lenses have to be removed. Furthermore, once the lens is removed, it is not easy to accurately affix the lens so that 3D images can be displayed again.

Thus, there is a demand for the development of technology that can easily switch between 3D display and 2D display on one screen using the lenticular method.

The present invention was made in view of the problems described above, and aims to provide a display device that can easily switch between 3D display and 2D display on one screen even using a lenticular method.

### Means for Solving the Problems

In order to solve the problems described above, a display device according to one aspect of the present invention is a display device for performing two-dimensional display and three-dimensional display of an image, the device including: a display unit that displays the image; a plurality of cylindrical convex lenses that are arranged in parallel on a screen of the display unit so that a longitudinal direction thereof is positioned along a straight line that links one end of the screen with another end; and a display control unit that determines whether the image is to be displayed two-dimensionally or three-dimensionally, depending on a proximity of the longitudinal direction of the lenses to one of a vertical direction and a horizontal direction, wherein the display control unit causes the image to be displayed three-dimensionally if the longitudinal direction of the lenses is proximate to the vertical direction, and causes the image to be displayed two-dimensionally if the longitudinal direction of the lenses is proximate to the horizontal direction.

In order to solve the problems described above, a control method according to one aspect of the present invention is a control method for a display device provided with a display unit that displays an image and a plurality of cylindrical convex lenses that are arranged in parallel on a screen of the display unit so that a longitudinal direction thereof is positioned along a straight line that links one end of the screen with another other end, the display device performing two-dimensional display and three-dimensional display of the image, the control method including: a display control step of determining whether the image is to be displayed two-dimensionally or three-dimensionally, depending on a proximity of the longitudinal direction of the lenses to one of a vertical direction and a horizontal direction, wherein, in the display control step, the image is caused to be displayed three-dimensionally if the longitudinal direction of the lenses is closer to the vertical direction, and the image is caused to be displayed two-dimensionally if the longitudinal direction of the lenses is closer to the horizontal direction.

According to the above-mentioned configuration, one aspect of the present invention is a display device that has a plurality of cylindrical convex lenses arranged in parallel on a screen and that performs two-dimensional and three-dimensional display of an image. Specifically, by controlling the orientation in which the image is to be displayed according to the orientation of the longitudinal direction of the lenses arranged on the screen, it is possible to switch between two-dimensional display and three-dimensional display on one screen.

In one aspect of the present invention, the lenses arranged on the screen have an elongated cylindrical convex shape, and light that hits the protruding part of the lenses, namely the cylindrical convex part, is refracted due to the optical characteristics thereof. Because of this, the image (light) displayed on the screen moves along a prescribed direction according to the entry position to the lenses. A three-dimensional display technology using such a lens typically displays the left and right parallax images in stripes by alternately arranging the images side by side, and lets the viewer view a stereoscopic image by parallax images travelling forward to the left and right, respectively, by passing through the lenses, and entering the left and right eye of the viewer.

When using a lens of the above-mentioned shape, the image displayed to the region where the lenses are provided is divided into the left eye and right eye of the viewer, thus a two-dimensional image is not displayed. However, according to one aspect of the present invention, by rotating the image and then displaying the image, namely by viewing the image from the front in a location where the screen was rotated, it is possible to perform two-dimensional display even in the region with lenses arranged thereon.

Thus, in one aspect of the present invention, the image is displayed after determining the orientation of the image depending on the proximity of the longitudinal direction of the lenses to one of the vertical direction and horizontal direction. For example, if the screen is rectangular and the lenses are arranged in parallel along the short side of the screen, then when the longitudinal direction of the lenses is proximate to the vertical direction, the screen is considered as being viewed in a landscape state, so the image is displayed in a direction perpendicular to the longitudinal direction. In this case, because the image to be displayed is divided into left and right by the optical characteristics of the lenses, a stereoscopic image is viewed by the viewer. On the other hand, when the longitudinal direction of the lenses is proximate to the horizontal direction, the screen is considered as being viewed in a portrait state, so the image is displayed in a direction parallel to the longitudinal direction. In this case, the optical characteristics of the lens lose that effect, and since the image to be displayed enters the eyes of the viewer by being divided into up and down directions, a two-dimensional image is viewed.

There is a problem with text or the like becoming hard to see when displayed three-dimensionally, and in some cases there is the possibility that the user wishes to have a 2D display, for example. Therefore, if it is possible to easily switch between two-dimensional display and three-dimensional display, a display suited to the needs of the user can be provided.

In one aspect of the present invention, the orientation of the image to be displayed is switched according to the longitudinal direction of the lenses, namely the orientation of the screen. Thus, it is possible for the viewer to view a two-dimensional image and a three-dimensional image by merely changing the orientation of the screen.

The above-mentioned display device may be realized by a computer. In this case, a program for operating a computer as the respective units mentioned above, and also a computer-readable recording medium that has recorded the program enter the scope of one aspect of the present invention.

Additional objects, features, and effects of the present invention shall be readily understood from the descriptions that follow. Advantages of the present invention shall become apparent by the following descriptions with reference to the appended drawings.

### Effects of the Invention

A display device according to one aspect of the present invention is a display device for performing two-dimensional display and three-dimensional display of an image, including: a display unit that displays the image; a plurality of cylindrical convex lenses that are arranged in parallel on the screen of the display unit so that the longitudinal direction thereof is positioned along a straight line that links one end of the screen with another end; and a display control unit that determines whether the image is to be displayed two-dimensionally or three-dimensionally, depending on the proximity of the longitudinal direction of the lenses to one of the vertical direction and horizontal direction, and if the longitudinal direction of the lenses is proximate to the vertical direction, the display control unit causes the image to be displayed three-dimensionally, and if the longitudinal direction of the lenses is proximate to the horizontal direction, the display control unit causes the image to be displayed two-dimensionally, and thus even with a lenticular method, it is possible to switch between 3D display and 2D display on one screen with ease.

### BRIEF DESCRIPTION OF THE DRAWINGS

FIG. 1 is a view showing a configuration of a display device according to one embodiment of the present invention.

FIG. 2 is a view showing arrangements of a pixel array and lenses 2 during three-dimensional display.

FIG. 3 is a view showing the appearance of the left and right parallax images entering the eyes of the viewer when the pixel array and lenses 2 are arranged as shown in FIG. 2.

FIG. 4 is a view showing a stereoscopic image synthesized from the left and right parallax images.

FIG. 5 is a view showing an arrangement of the pixel array and lenses 2 during two-dimensional display.

FIG. 6 is a view showing the appearance of the left and right parallax images entering the eyes of the viewer when the pixel array and lenses 2 are arranged as shown in FIG. 5.

FIG. 7 is a view showing an arrangement of the pixel array and lenses 2 during two-dimensional display.

FIG. 8 is a view showing the appearance of the images entering the eyes of the viewer when the pixel array and lenses 2 are arranged as shown in FIG. 7.

FIG. 9 is a view showing another configuration example of the display device according to one embodiment of the present invention.

### DETAILED DESCRIPTION OF EMBODIMENTS

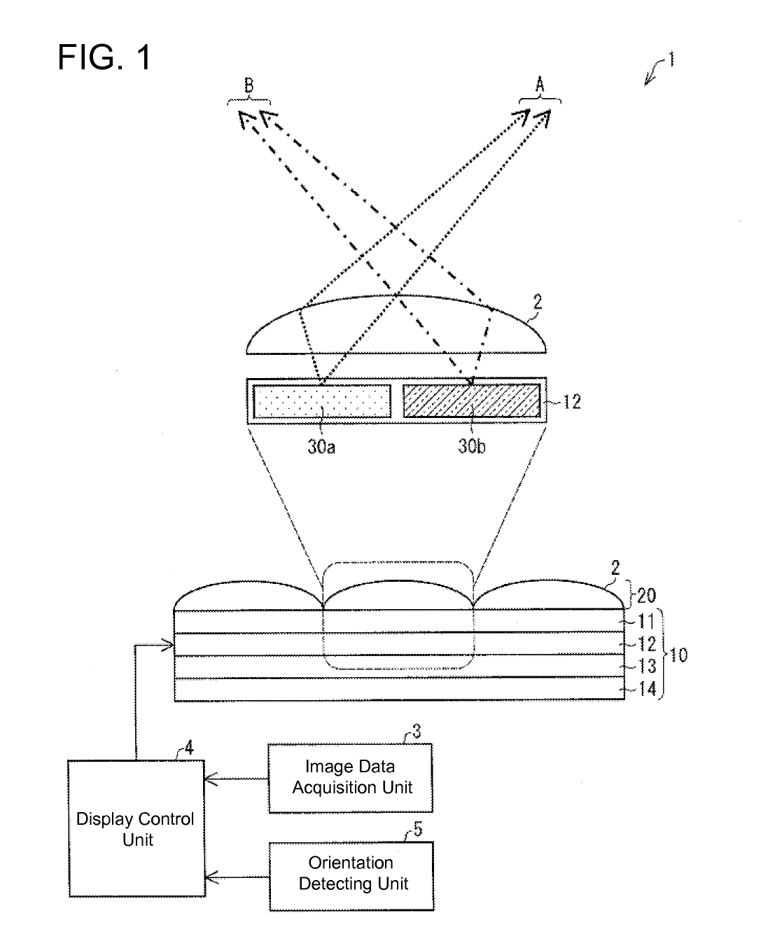

The embodiments of the present invention will be explained in detail below with reference to FIGS. 1 to 9.

### Embodiment 1

(Configuration of Display Device)

FIG. 1 is a view showing a configuration of the display device 1 according to one embodiment of the present invention. As shown in FIG. 1, the display device 1 is provided with a display unit 10, a lenticular lens 20, an image data acquisition unit 3, a display control unit 4, and an orientation detecting unit 5.

The display device 1 of the present embodiment has a configuration with a plurality of cylindrical convex lenses 2 arranged in parallel on a screen, and performs two-dimensional display and three-dimensional display of an image. Specifically, by controlling the orientation in which the image is to be displayed according to the orientation of the longitudinal direction of the lenses 2 arranged on the screen, it is possible to switch between two-dimensional display and three-dimensional display on one screen.

In the display device 1, the lenses 2 arranged on the screen have an elongated cylindrical convex shape, and light that hits the protruding part of the lenses 2, namely the cylindrical convex part, is refracted due to the optical characteristics thereof. Because of this, the image (light) displayed on the screen moves along a prescribed direction according to the entry position to the lenses 2. A three-dimensional display technology using such a lens 2 typically displays the left and right parallax images in stripes by alternately arranging the images side by side, and lets the viewer view a stereoscopic image by parallax images travelling forward to left and right, respectively, by passing through the lenses 2 and entering the left eye and right eye of the viewer.

A parallax image is an image with a slightly shifted viewpoint due to an object being imaged from multiple directions, and when one of the left and right parallax images enters the left eye of the viewer and the other enters the right eye, a stereoscopic image (a three-dimensional image) is viewed by the viewer. For convenience of explanation, the image to be viewed by the left eye of the viewer during three-dimensional display will be referred to below as a left-eye image, and the image to be viewed by the right eye of the viewer will be referred to as a right-eye image.

When using lenses 2 of the above-mentioned shape, the image displayed in the region provided with the lenses 2 is divided into the left eye and right eye of the viewer, thus a two-dimensional image is not displayed. However, according to the display device 1, by displaying a rotated image, or in other words, by displaying the image so as to be viewed from the front in a location where the screen was rotated, it is possible to perform two-dimensional display even in the region with lenses 2 arranged thereon.

In the display device 1, whether to perform two-dimensional display or to perform three-dimensional display is determined depending on the proximity of the longitudinal direction of the lenses 2 to one of the vertical direction and the horizontal direction. Specifically, if the longitudinal direction of the lenses 2 is proximate to the vertical direction, a three-dimensional display of the image is performed, and if the longitudinal direction of the lenses 2 is proximate to the horizontal direction, a two-dimensional display of the image is performed.

As in the present embodiment, if the screen is rectangular and the lenses 2 are arranged in parallel along the short side of the screen, then when the longitudinal direction of the lenses 2 is vertical, the screen is considered as being viewed in a landscape state, so the image is displayed in a direction perpendicular to the longitudinal direction. In this case, because the image to be displayed is divided into left and right by the optical characteristics of the lenses 2, a stereoscopic image is viewed by the viewer. On the other hand, when the longitudinal direction of the lenses 2 is horizontal, the screen is considered as being viewed in a portrait state, so the image is displayed in a direction parallel to the longitudinal direction. In this case, the optical characteristics of the lenses 2 lose that effect, and since the image to be displayed enters the eyes of the viewer by being vertically divided, a two-dimensional image is viewed.

As described above, according to the display device 1, the orientation of the image to be displayed is switched according to the longitudinal direction of the lenses 2, namely the orientation of the screen. Thus, it is possible for the viewer to view a two-dimensional image and a three-dimensional image by merely changing the orientation of the screen.

The display unit 10 displays an image acquired by the image data acquisition unit 3. The display unit 10 of the present embodiment, as shown in FIG. 1, is a liquid crystal display provided with a panel 12, polarizing plates 11 and 13, and a backlight 14. If the display unit 10 is a liquid crystal display, it is possible to realize two-dimensional display and three-dimensional display on one screen in various display devices that use liquid crystal displays. However, the display unit 10 is not limited to the above-mentioned configuration, and can also apply to a CRT (cathode ray tube) display, a plasma display, an organic EL (electroluminescence) display, or the like, for example.

The lenticular lens 20, which has a configuration of a lens plate with a plurality of elongated cylindrical convex lenses 2 arranged side by side, is placed over the screen of the display unit 10. As shown in FIG. 1, when the left and right parallax images 30a and 30b, which are alternately arranged side by side, enter the inside of the lens 2, the images that hit the protruding part, which is the boundary with the outside, are respectively guided to the left and right in the directions of arrows A and B and displayed. Therefore, when a three-dimensional display is to be performed, namely when the images are displayed in an orientation perpendicular to the longitudinal direction of the lenses 2, the lenticular lens 20 may be placed over the screen so that each lens 2 corresponds to two columns of adjacent pixels that respectively display the left and right parallax images.

In the present embodiment, the respective pixels alternately display the left and right parallax image, and therefore, the lenses 2 are placed so as to correspond to the respective two columns of pixels, but the number of columns of pixels that correspond to each lens 2 may be appropriately determined depending on the pixel array displaying the parallax images.

The image data acquisition unit 3 acquires image data that is displayed in the display unit 10, and sends the acquired image data to the display control unit 4. The image data to be acquired may be either a still image or a moving image, and includes two-dimensional display image data and three-dimensional display image data.

The three-dimensional display image data is data that includes the left and right parallax images, and the two-dimensional display image data is data that does not include the left and right parallax images. However, the image data used during two-dimensional display is not limited to the two-dimensional display image data, and if the longitudinal direction of the lenses 2 is horizontal then it is possible to perform two-dimensional display by using the three-dimensional display image data. Three-dimensional data may be parallax images created in advance by shifting the viewpoint and acquired from an external device, or may be parallax images created from one image by a mechanism provided inside the display device 1 and obtained from the mechanism, for example.

The display control unit 4 determines the orientation of the image depending on the proximity of the longitudinal direction of the lenses 2 to one of the vertical direction and the horizontal direction, and causes the image to be displayed. In the present embodiment, the orientation of the image the display control unit 4 causes to display is either perpendicular or parallel to the longitudinal direction of the lenses 2, that is, a location where an image is viewed from the front when the screen is portrait or landscape. In other words, the image is switched to a vertical orientation or a horizontal orientation.

The timing for when the display control unit 4 switches the orientation of the image may be when the orientation of the lenses 2 detected by the orientation detecting unit 5 switches from a state proximate to one of the vertical direction and horizontal direction to the opposite state, for example. In other words, the orientation may be switched automatically. However, the present embodiment is not limited to this, and if the display device is configured so as to accept user instruction such as whether to perform two-dimensional display or three-dimensional display of an image, the orientation of the image may be changed when the instructions are received, for example.

The orientation detecting unit 5 detects whether the longitudinal direction of the lenses 2 is proximate to the vertical direction or the horizontal direction, and outputs detected information to the display control unit 4.

(Principles of Three-Dimensional Image Display)

Next, the principles for displaying three-dimensional images in the display device 1 will be explained.

As described above, the display device 1 is equipped with a lenticular lens 20, and adopts the so-called lenticular method in which images are passed through the lenticular lens 20 and displayed, thereby letting the viewer view a stereoscopic image.

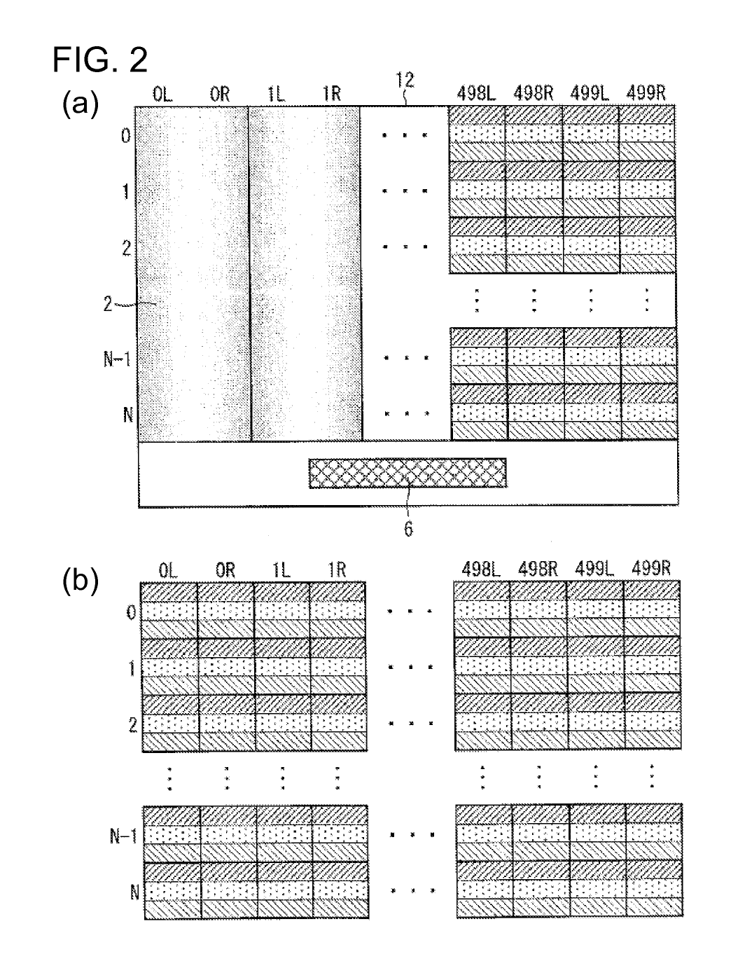

FIG. 2 is a view showing arrangements of the pixel array and lenses 2 during three-dimensional display. As shown in FIG. 2, in the pixel array during three-dimensional display, the left and right parallax images are displayed in stripes (horizontal stripes) by being alternately arranged side by side. In FIG. 2, the columns where the left-eye images are displayed are the columns affixed with an “L” such as “0L” and “499L,” and the columns where the right-eye images are displayed are the columns affixed with an “R” such as “0R” and “499R.” Below the panel 12, a driver IC 6 is mounted using a COG (Chip On Glass) method, and image data acquired by the image data acquisition unit 3 is outputted to the pixels.

Lenses 2 are arranged in parallel so that the longitudinal direction thereof is positioned along vertical lines with respect to the display unit 10 in which the pixels are arranged in the above-mentioned manner, and image data is written so that the image is displayed in an orientation determined by the display control unit 4.

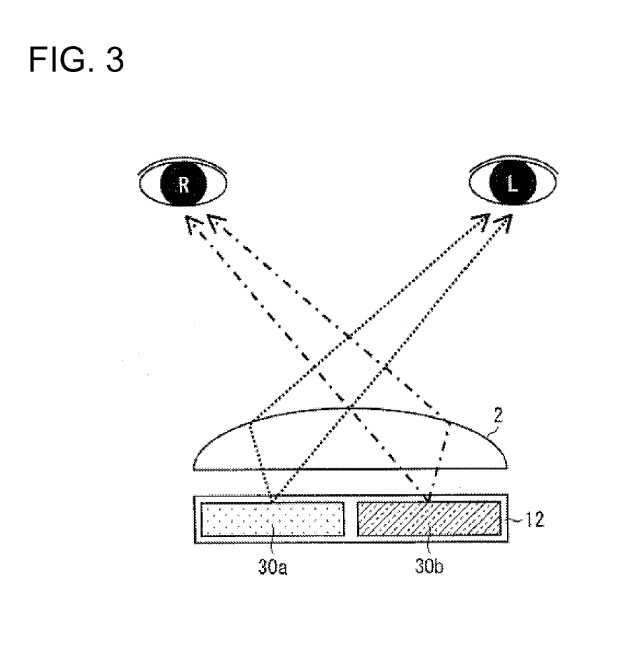

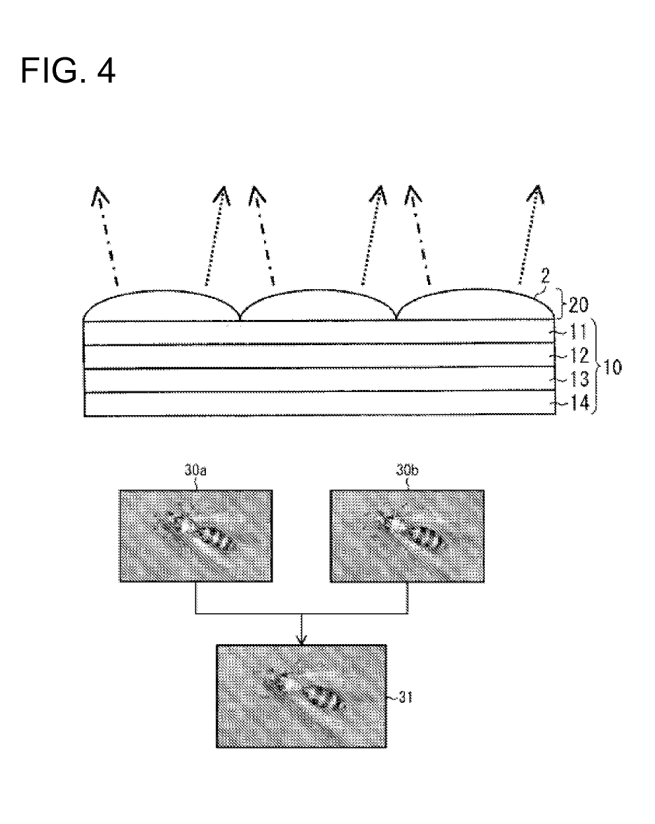

The image displayed in the panel 12 enters the lenses 2 via a polarizing plate 11. As described above, the lenticular lens 20 of the present embodiment is placed so each lens 2 corresponds to two adjacent columns of pixels that display the left and right parallax images, and therefore, the parallax images travel forward while being respectively guided to the left and right. FIG. 3 is a view showing the appearance of the left and right parallax images entering the eyes of the viewer when the pixels and lenses 2 are arranged as shown in FIG. 2, and FIG. 4 is a view showing a stereoscopic image synthesized from the left and right parallax images.

As shown in FIG. 3, when the image displayed in the display unit 10 passes through the lenticular lens 20, the image is divided to the left and right. Therefore, the left-eye image 30a enters the left eye of the viewer, and the right-eye image 30b enters the right eye of the viewer. As a result, the images that entered the left eye and right eye appear as a stereoscopic image 31 as shown in FIG. 4.

In this way, it is possible for the viewer to enjoy interesting three-dimensional displays with the display device 1.

(Switching Between Three-Dimensional Display and Two-Dimensional Display)

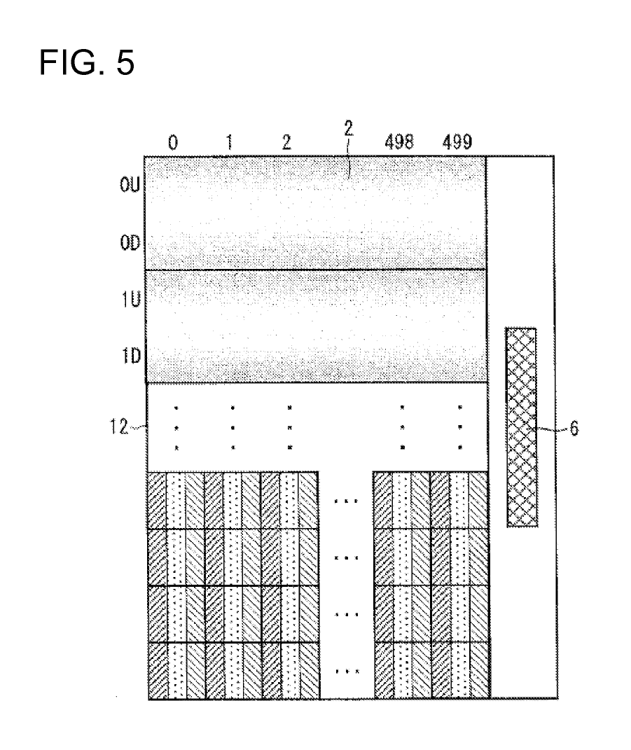

The display device 1 of the present embodiment is configured so as to be able to switch between three-dimensional display and two-dimensional display on one screen. FIG. 5 is a view showing an arrangement of the pixel array and lenses 2 during two-dimensional display.

In the display device 1, when turned 90 degrees to the left side from a state of three-dimensional display, the screen changes from landscape to portrait, and the longitudinal direction of the lenses 2 changes from vertical to horizontal. At this time, in the pixel array of the panel 12, the left and right parallax images, which are the same image data as during the three-dimensional display described above, are displayed in stripes (vertical stripes) by being alternately arranged vertically. In FIG. 5, the lines where the left-eye images are displayed during three-dimensional display are the lines affixed with a “U” such as “0U” and “1U,” and the lines where the right-eye images are displayed during three-dimensional display are the lines affixed with a “D” such as “0D.” Image data is outputted from the driver IC 6 located on the right side of the panel 12 such that the image is displayed in the orientation determined by the display control unit 4 at the pixels, namely in the direction rotated to the left 90 degrees.

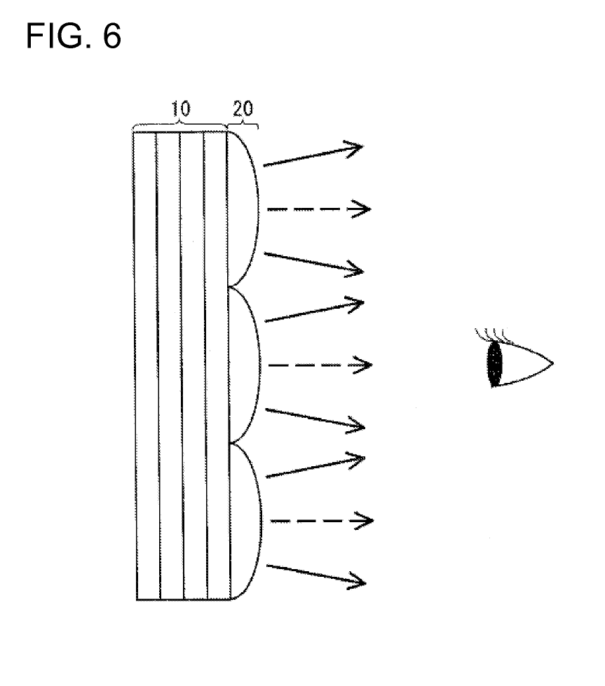

The image displayed in the panel 12 enters the lenses 2 via the polarizing plate 11, but since the orientation of the lenses 2 is different from during three-dimensional display, the left and right parallax images travels forward while being guided to the up and down directions. FIG. 6 is a view showing the appearance of the left and right parallax images entering the eyes of the viewer when the pixels and lenses 2 are arranged as shown in FIG. 5.

As shown in FIG. 6, when the image displayed in the display unit 10 passes through the lenticular lens 20, the displayed image is divided into up and down directions. Therefore, the left and right parallax images enter both eyes of the viewer. As a result, the viewer does not view a stereoscopic image, but rather a two-dimensional image.

In order to rotate the image towards the orientation determined by the display control unit 4, an input image signal may be rotated 90 degrees in a not-shown control unit such as a CPU (or a microcomputer), and the post-rotation image data may be sent to the display unit 10. The image can thereby be displayed in the orientation determined by the display control unit 4.

As described above, it is possible to perform two-dimensional display in the display device 1 even via the lenticular lens 20, so two-dimensional display can be performed when images that are hard to see in three-dimensional display such as text are to be displayed, or in some cases, depending on the desires of the user, for example.

Since the same image is inputted during landscape display as during portrait display, a two-dimensional image is still viewed even if the viewpoint of the user shifts slightly from a state of viewing the screen from the front during portrait display.

In FIG. 5, the location of the driver IC 6 is on the right side of the plurality of pixels arranged over the panel 12, but the location of the driver IC 6 may also be on the left side.

### Embodiment 2

In the present embodiment, only the image data and the pixel array used during two-dimensional display differ from Embodiment 1, and other configurations are similar to those of Embodiment 1. Therefore, elements with the same configuration are given the same reference characters and the descriptions thereof will not be repeated.

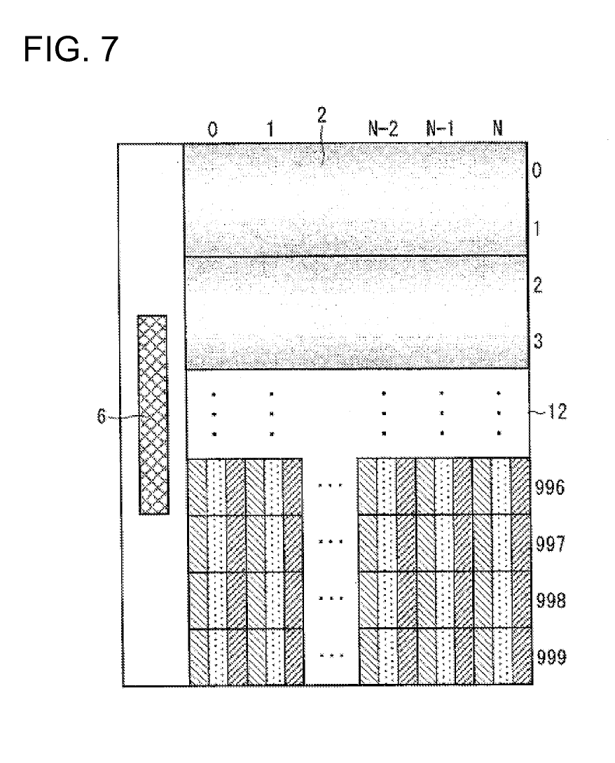

The display device 1 may use image data that differs from image data used during three-dimensional display, when switching to two-dimensional display. In other words, when going from three-dimensional display to two-dimensional display, it is possible to switch image data for three-dimensional display containing parallax images to image data for two-dimensional display, along with rotating the orientation of the image to be displayed. FIG. 7 is a view showing an arrangement of the pixel array and lenses 2 during two-dimensional display.

In the display device 1, when turned 90 degrees to the right side from a state of three-dimensional display, the screen changes from landscape to portrait, and the longitudinal direction of the lenses 2 changes from vertical to horizontal. At this time, in the pixel array of the panel 12, image data for two-dimensional display is arranged vertically and displayed. In order to display the orientation determined by the display control unit 4 at these pixels, namely the image that has been rotated to the right 90 degrees, image data is outputted from the driver IC 6 located on the left side of the panel 12.

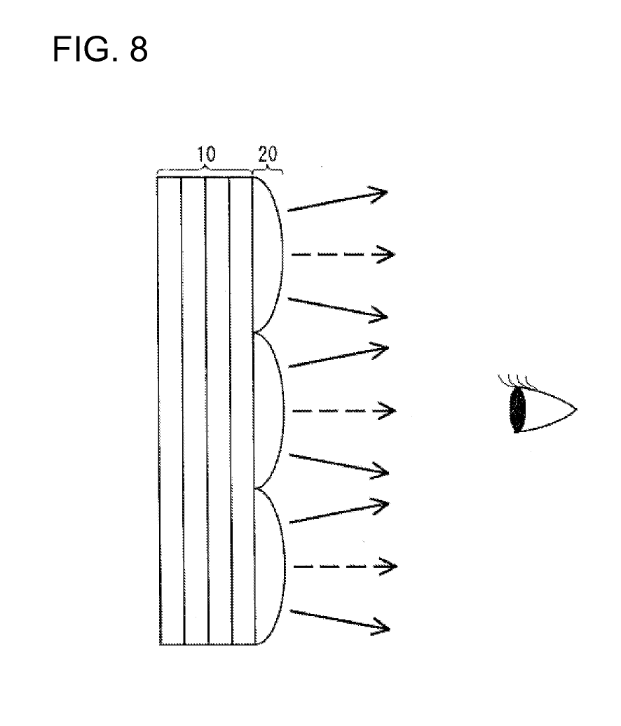

The image displayed in the panel 12 enters the lenses 2 via the polarizing plate 11, but since the orientation of the lenses 2 is different from during three-dimensional display, the images that have entered the lenses 2 travel forward while being guided into up and down directions, respectively. FIG. 8 is a view showing the appearance of the images entering the eyes of the viewer when the pixels and lenses 2 are arranged as shown in FIG. 7.

As shown in FIG. 8, when the image displayed in the display unit 10 passes through the lenticular lens 20, the displayed image is divided into up and down directions. Therefore, the image enters both eyes of the viewer, so the viewer does not view a stereoscopic image, but rather a two-dimensional image.

With this method, the image data is changed to that used for a two-dimensional display following the rotation of the image. Thus the image quality is not reduced by half compared to during two-dimensional display, and the displayed image can have double the resolution compared to the three-dimensional display image in which an image is divided to a right-eye image and a left-eye image.

### Embodiment 3

In the present embodiment, only the rotation method of the image towards the orientation determined by the display control unit 4 differs from Embodiment 1, and other configurations are similar to those of Embodiment 1. Therefore, the elements with the same configuration are given the same reference characters and the descriptions thereof will not be repeated.

The display device 1 of the present embodiment has a configuration equipped with a frame memory (not shown) inside of the drive IC 6. In the display device 1 of such a configuration, the image is rotated towards the orientation determined by the display control unit 4 as follows.

First, the image data (input image signal) that the image data acquisition unit 3 acquires is temporarily stored in the frame memory inside the driver IC 6. Next, there is inversion processing in the driver IC 6 of the input image signal retrieved from the frame memory. The inversed input image signal is subjected to gamma processing and the like, and outputted to a source driver. As a result, an image that has been rotated 90 degrees to the orientation determined by the display control unit 4 is displayed on the screen.

In this way, the display device 1 can be configured such that an image is displayed after being rotated in the driver IC 6.

As described above, according to the display device 1 of the above-mentioned embodiments, it is possible to switch between two-dimensional display and three-dimensional display on one screen without shifting or removing the lenticular lens 20, and thus a display suited to the needs of the user can be provided.

In addition, it is possible to switch freely between two-dimensional display and three-dimensional display by merely changing the orientation of the screen, and so the display device 1 can be applied to various types of portable communication devices such as a personal digital assistant (PDA), a portable computer, or a mobile phone. Thus, it is possible to easily enjoy interesting three-dimensional displays in various scenarios, and by using two-dimensional display when e-mail, text data, or the like is displayed, the text can be made easier to see.

Additionally, since the display device 1 uses a lenticular method, there is no reduction of brightness as in the parallax barrier method. Because of this, images can be displayed at the desired brightness without adjusting the output of the backlight 14.

### Embodiment 4

In the present embodiment, only the location of the driver IC 6 with respect to the plurality of pixels arranged over the panel 12 differs from Embodiment 1, and other configurations are similar to those of Embodiment 1. Therefore, the elements with the same configuration are given the same reference characters and the descriptions thereof will not be repeated.

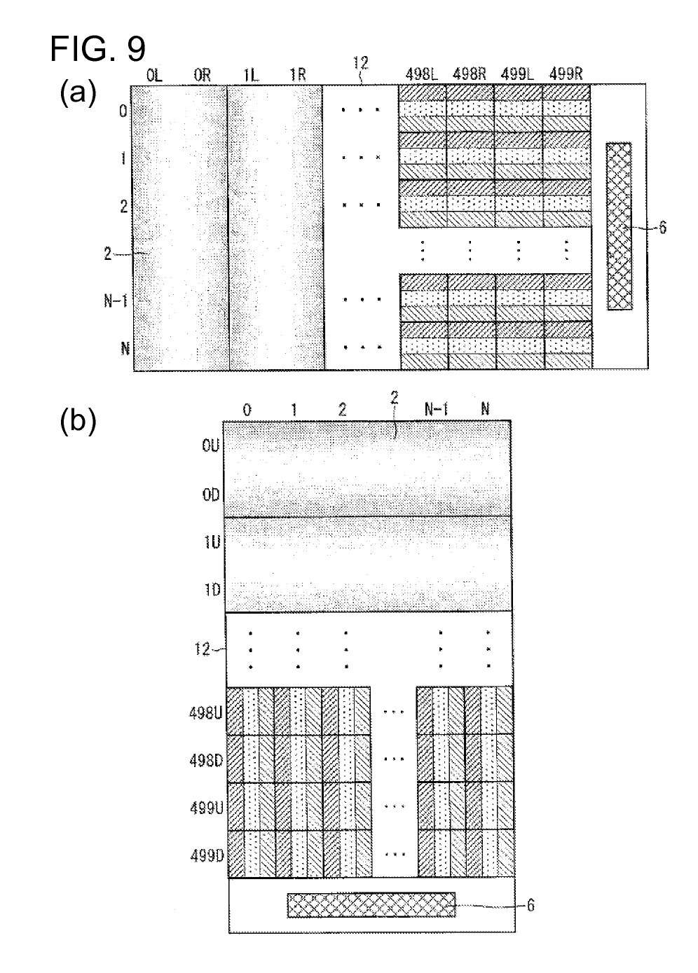

FIG. 9 is a view showing another configuration example of the display device 1 according to one embodiment of the present invention.

In the display device 1 of the present embodiment, the driver IC 6 is arranged in a location on the right side of the plurality of pixels when the screen is in landscape. The location of the driver IC 6 may also be below, at sides, or on the left side or right side of the plurality of pixels when the screen is in landscape.

Even with such a configuration, the user is able to easily switch between three-dimensional display and two-dimensional display by rotating the screen horizontally or vertically.

In the embodiments described above, the display device 1 in which the screen is rectangular is described as an example, but the present invention is not limited to this, and the screen may be square or other forms, for example. Furthermore, the present invention is not limited as to whether three-dimensional display or two-dimensional display is performed when the screen is portrait or landscape, and may be appropriately set according to the specifications and the like of the device.

<Program and Recording Medium>

Finally, the respective units included in the display device 1 may be constituted of hardware logic. The respective units may also be realized by software using a CPU as follows.

The display device 1 is provided with a CPU that executes instructions of the program that implements the functions, a ROM containing the program, a RAM to develop the program in a format capable of executing the program, and a storage device (recording medium) such as a memory for storing the program and various types of data. With this configuration, the aim of the present invention can also be achieved by a prescribed recording medium.

The recording medium may record the program code (executable program, intermediate code program, source program) of the program of the display device 1, which is the software that implements the functions described above in a way readable on a computer. The recording medium is supplied to the display device 1. Thus, the display device 1 (or a CPU and MPU) as a computer may read the program code recorded on the supplied recording medium and execute the program code.

The recording medium that supplies the program code to the display device 1 is not limited to a specific configuration or type. The recording medium can be a tape such as a magnetic tape or a cassette tape; disks that includes a magnetic disk such as a floppy disk (registered trademark)/hard disk and an optical disc such as a CD-ROM/MO/MD/DVD/CD-R; a card such as an IC card (including a memory card)/optical card; or a semiconductor memory such as a mask ROM/EPROM/EEPROM/flash ROM, for example.

Also, the aim of the present invention can be achieved even if the display device 1 is configured to be connectable to a communication network. In this case, the program code is supplied to the display device 1 via a communication network. The communication network may supply the program code to the display device 1, and is not limited to a specific type or form. For example, the communication network may be an internet, intranet, extranet, LAN, ISDN, VAN, CATV communication network, VPN (Virtual Private Network), telephone network, mobile communication network, satellite communication network, or the like.

The transmission medium that constitutes this communication network may also be any medium capable of transmitting the program code, and is not limited to a specific configuration or type. It is possible to use a fixed line such as an IEEE1394, USB, power line carrier, cable TV circuit, telephone line, ADSL (Asymmetric Digital Subscriber Line) circuit; or wireless such as infrared like IrDA and a remote control, Bluetooth (registered trademark), 802.11 wireless, HDR, mobile phone network, satellite circuit, or a terrestrial digital network, for example.

The present invention is not limited to the embodiment described above, and various modifications can be made without departing from the scope of the claims. Therefore, embodiments obtained by appropriately combining the techniques disclosed in the embodiment are included in the technical scope of the present invention.

The present invention is not limited to the respective embodiments described above, and various modifications can be made without departing from the scope of the claims. Therefore, embodiments obtained by appropriately combining the techniques respectively disclosed in different embodiments are included in the technical scope of the present invention.

### Summary of Embodiments

As described above, it is preferable for the display device according to one aspect of the present invention to be provided with a detecting unit that detects whether the longitudinal direction of the lenses is proximate to the vertical direction or the horizontal direction, and for the display control unit to cause the image to be displayed after determining the orientation of the image based on the results detected by the detecting unit.

According to the above-mentioned configuration, whether the longitudinal direction of the lenses is proximate to the vertical direction or horizontal direction, or namely what kind of state the orientation of the screen is in, is detected by the display device, and thus, it is possible to automatically switch between two-dimensional display and three-dimensional display.

In the display device according to one embodiment of the present invention, it is preferable for the display unit to be a liquid crystal display. With this configuration, it is possible to realize two-dimensional display and three-dimensional display on one screen in various display devices using liquid crystal displays.

In the display device according to one aspect of the present invention, it is preferable for the display device to be a portable communication device. If the display device according to one aspect of the present invention is a portable communication device, it is possible to easily enjoy interesting three-dimensional displays in various scenarios, and by using two-dimensional display when e-mail, text data, or the like is displayed, the text can be made easier to see.

The specific embodiments and examples provided in the detailed description of the present invention section are merely for illustration of the technical contents of the present invention. The present invention shall not be narrowly interpreted by being limited to such specific examples. Various changes can be made within the spirit of the present invention and the scope as defined by the appended claims.

### INDUSTRIAL APPLICABILITY

The present invention can be applied to various types of portable communication devices such as a personal digital assistant (PDA), a portable computer, or a mobile phone.

### DESCRIPTION OF REFERENCE CHARACTERS

1 display device
2 lens
3 image data acquisition unit
4 display control unit (display control means)
5 orientation detecting unit (detecting means)
10 display unit
20 lenticular lens

1. A display device for performing two-dimensional display and three-dimensional display of an image, comprising:
a display unit that displays the image;
a plurality of cylindrical convex lenses that are arranged in parallel on a screen of the display unit so that a longitudinal direction thereof is positioned along a straight line that links one end of said screen with another end; and
a display control unit that determines whether the image is to be displayed two-dimensionally or three-dimensionally, depending on an orientation of the screen determined by an orientation of the longitudinal direction of the lenses relative to a vertical direction and a horizontal direction,
wherein the display control unit causes the image to be displayed three-dimensionally if the longitudinal direction of the lenses is determined to be closer to the vertical direction than the horizontal direction, and causes the image to be displayed two-dimensionally if the longitudinal direction of the lenses is determined to be closer to the horizontal direction.

2. The display device according to claim 1, further comprising a detecting unit that detects whether the longitudinal direction of the lenses is closer to the vertical direction or the horizontal direction,
wherein the display control unit causes the image to be displayed after determining an orientation of the image based on a result detected by the detecting unit.

3. The display device according to claim 1, wherein the display unit is a liquid crystal display.

4. The display device according to claim 1, wherein the display device is a portable communication device.

5. A control method for a display device provided with a display unit that displays an image and a plurality of cylindrical convex lenses that are arranged in parallel on a screen of the display unit so that the longitudinal direction thereof is positioned along a straight line that links one end of said screen with another end, the display device performing two-dimensional display and three-dimensional display of the image, the method comprising:
a display control step of determining whether the image is to be displayed two-dimensionally or three-dimensionally, depending on an orientation of the screen determined by an orientation of the longitudinal direction of the lenses relative to a vertical direction and a horizontal direction,
wherein, in the display control step, the image is caused to be displayed three-dimensionally if the longitudinal direction of the lenses is determined to be closer to the vertical direction than the horizontal direction, and the image is caused to be displayed two-dimensionally if the longitudinal direction of the lenses is determined to be closer to the horizontal direction.

6. A program for operating a computer provided in the display device according to claim 1, wherein the program makes the computer function as the respective units.

7. A recording medium that is computer-readable, having the program according to claim 6 recorded therein.
